(19) United States
(12) Patent Application Publication
(10) Pub. No.: US 2006/0073072 A1
(43) Pub. Date: Apr. 6, 2006

(54) Reagent carrier

(75) Inventor: Peter Rudloff, Ladenburg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: scil animal care company GmbH, Viernheim (DE)

(21) Appl. No.: 11/238,784

(22) Filed: Sep. 29, 2005

(30) Foreign Application Priority Data
Sep. 29, 2004 (DE) 10 2004 047 822.8

(51) Int. Cl. G01N 21/64

(52) U.S. Cl. 422/56; 422/68.1; 422/58

(57) ABSTRACT

A reagent carrier (1) having a supporting body (2) for insertion into an analyzer unit and having at least one cavity (3, 3′, 3″) formed in the supporting body (2) for receiving a reagent for analyzing a bodily fluid, in particular blood serum or blood plasma. The reagent carrier is characterized in that the supporting body (2) has an elongated basic design having longitudinal sides (4, 4′) and transversal sides (5, 5′), and the transversal sides (5, 5′) differ in length.

This claims the the benefit of German Patent Application No. 10 2004 047 822.8, filed Sep. 29, 2004 and hereby incorporated by reference herein.

### BACKGROUND

The present invention relates to a reagent carrier having a supporting body for insertion into an analyzer unit and having at least one cavity formed in the supporting body for receiving a reagent for analyzing a bodily fluid, in particular blood serum or blood plasma, and also relates to a transport container having such a reagent carrier.

In human and veterinary medicine, the state of health of the patients is routinely investigated by determining the substrate concentrations in blood serum and blood plasma on the basis of chemical reactions, as well as by measuring enzyme activities and by evaluating the large molecules in these fluids using immunological tests. To perform these measurements, semi- and fully automated analyzer units have been developed, which enable the desired investigations to be carried out in simple processes. In this context, the reagents typically used for making the various determinations may differ, depending on the desired investigation.

When working with the analyzer units used in relatively small laboratories, such as those found in medical or veterinary practices, the problem arises of supplying the reagents needed in each case in a simple manner. In this connection, it must be taken into consideration that different assays require different reagents or combinations thereof.

### SUMMARY OF THE INVENTION

An object of the present invention is to devise a reagent carrier which will be easy to manipulate.

The present invention provides a reagent carrier of the type mentioned at the outset and further provides the supporting body with an elongated basic design having longitudinal sides and transversal sides, and by designing the transversal sides to differ in length.

A reagent carrier of this kind may be used in a simple manner in an analyzer unit. It is suited, in particular, for receiving a one-time dose of a reagent or of a combination of reagents required for an assay. Moreover, the reagent carrier according to the present invention advantageously renders possible a space-saving, circular array of the reagent carriers, disposed side-by-side on a rotatively mounted holding plate of the analyzer unit. The design which includes transversal sides of different lengths makes it possible for a large number of reagent carriers to be provided in the analyzer unit. At the same time, the design according to the present invention prevents the reagent carriers from being incorrectly inserted into the analyzer unit or into its holding plate.

It has proven effective for the space-saving arrangement, for the longitudinal sides to be angled relative to one another. The longitudinal sides preferably form an angle of between 10° and 20°, in particular of between 13° and 17°. In accordance with one advantageous embodiment of the present invention, the longitudinal sides are 25 mm to 35 mm long, in particular between 28 mm and 32 mm long.

The shorter transversal side is preferably between 7 mm and 9 mm long, and the longer transversal side between 14 mm and 18 mm long.

By providing a plurality of cavities, in particular three, a suitable number of reagents may be supplied in various combinations in one single reagent carrier.

The process of supplying the typically different quantities of reagents required for an assay is improved in that the cavities vary in size. This makes it possible to supply the amount of reagent required for the particular case, while, at the same time, keeping the contact with oxygen to a minimum. In this context, it has proven effective for the volume of the first cavity to be 250 to 350 ml and/or for the volume of the second cavity to be 100 to 150 ml and/or for the volume of the third cavity to be 60 to 100 ml.

The automatic processing of the reagents in the analyzer unit is simplified by arranging the cavities side-by-side, in a straight line, since this enables one needle to be used for all of the cavities, the needle moving along a straight path to draw the reagents.

It is, moreover, provided in accordance with the present invention for one reagent to be contained in the at least one cavity.

To enable the reagent or the reagents to be easily drawn from cavities, the at least one cavity is provided with a sampling orifice on the top side of the reagent carrier.

A further improvement is achieved by providing the at least one cavity with a filling orifice which is advantageously positioned on the bottom side of the reagent carrier.

The cavity is able to be filled more efficiently by designing the filling orifice to have a smaller orifice cross section than the sampling orifice. This makes it possible, in particular, to keep the gas phase contained in the cavity following the filling operation, to a minimum. The storage life of the reagents is thereby substantially improved.

It has proven to be beneficial for the orifice cross section of the filling orifice to be smaller than 20%, in particular smaller than 10% of the orifice cross section of the sampling orifice.

The filling properties of the reagent carrier are further improved by providing the filling orifice with an elongated, in particular oval form. Gas contained in the cavity is able to escape more easily during the filling operation, enabling the filling process to be carried out more quickly.

The handling of the reagent carrier is especially practical when the reagent is contained in liquid form in the at least one cavity.

The storage life of the reagent or of the reagents is influenced in a beneficial way when the air or gas bubble remaining above the liquid surface level of the reagent takes up less than 2% of the volume of the particular cavity. A further improvement is achieved when the air or gas bubble takes up less than 1%, in particular less than 0.5% of the volume of the particular cavity.

Sealing the sampling orifice and/or the filling orifice in each case by a protective film ensures that the filled reagent carrier is safely transported.

By providing the reagent carrier with machine-readable information pertaining to the reagent contained in the at least one cavity, i.e., the reagents contained in the cavities, it is possible to facilitate the automated processing of the assays. The information may be provided, in particular, in the form of a bar code or a dot code on the reagent carrier. On the basis of the machine-readable information, the analyzer unit is able to automatically verify that the correct reagent carrier required for an assay is being used. This makes it possible to avoid faulty measurements caused by the use of an incorrect reagent carrier.

The present invention also provides for a transport container, which includes a connecting segment for insertion into the analyzer unit and at least one receptacle chamber for a plurality of reagent carriers, at least one reagent carrier according to the present invention being contained in the receptacle chamber.

In accordance with one further refinement of this inventive idea, machine-readable information pertaining to the at least one reagent carrier contained in the container and/or pertaining to the reagents contained in the at least one reagent carrier is provided on or in the transport container.

The machine-readable information may be stored in a chip provided on the transport container.

More precise assay results are obtained when the machine-readable information of the transport container includes calibration data regarding the assays to be carried out using the reagents. On the basis of the calibration data, the analyzer unit is able to correct any deviations in the reagents from the nominal quality that would otherwise not be preventable or only preventable at great expense.

Other objectives, features, advantages and possible applications of the present invention may be derived from the following description of an exemplary embodiment, which makes reference to the drawing. In this context, all of the described and/or illustrated features constitute the subject matter of the present invention, either alone or in any combination, and regardless of the manner in which they are combined in individual claims or antecedents thereof.

### BRIEF DESCRIPTION OF THE DRAWINGS

FIG. 1 shows a plan view of an embodiment of a reagent carrier according to the present invention;

FIG. 2 shows the reagent carrier according to the FIG. 1 embodiment in a sectional view;

FIG. 3 shows the reagent carrier according to the FIG. 1 embodiment from below;

FIG. 4 shows the reagent carrier according to the FIG. 1 embodiment from the side;

FIG. 5 shows an embodiment of a transport container for reagent carriers, in accordance with the present invention, from above;

FIG. 6 shows the transport container according to the FIG. 5 embodiment in a sectional view;

FIG. 7 shows the transport container according to the FIG. 5 embodiment from the side;

FIG. 8 shows a holding plate of an analyzer unit, having reagent carriers according to the FIG. 1 embodiment.

### DETAILED DESCRIPTION

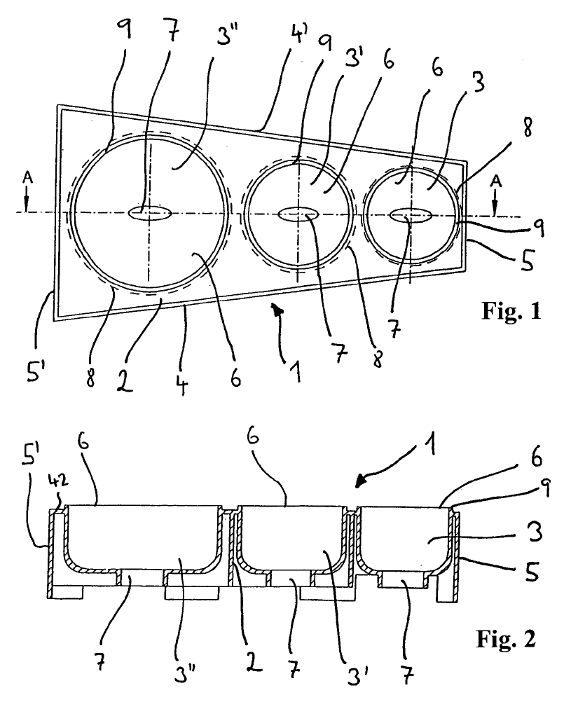

FIGS. 1 through 4 show a reagent carrier 1 which is to be inserted into an analyzer unit. Reagent carrier 1 has a supporting body 2 of plastic having at least one cavity 3, 3′, 3″ formed therein. In the present case, three cavities 3, 3′, 3″, disposed side-by-side in a straight line, are provided in the supporting body. Cavities 3, 3′, 3″ are each filled with reagents for analyzing bodily fluids, in particular blood serum and blood plasma.

Illustrated reagent carrier 1 makes it possible for the reagent or a combination of reagents needed for the assay in the analyzer unit to be supplied in one single reagent carrier 1. In this context, cavities 3, 3′, 3″ contain the quantity of reagents specifically required for one individual measurement. As a result, a quantity of reagents stored under defined conditions may be made available for the assay. In this way, any change in the reagents caused by relatively long contact with the air is avoided.

Supporting body 2 has an elongated basic design including two longitudinal sides 4, 4′and two transversal sides 5, 5′. The longitudinal sides are not arranged in parallel, but rather at an angle to one another, as shown. Accordingly, transversal sides 5, 5′ differ in length. Longitudinal sides 4, 4′ form an angle of between 10° and 20°, in particular of between 13° and 17°. Longitudinal sides 4, 4′ are 25 mm to 35 mm long, in particular between 28 mm and 32 mm long. Shorter transversal side 5 is between 7 mm and 9 mm long, while longer transversal side 5′ is between 14 and 18 mm long.

Cavities 3, 3′, 3″ vary in size. The volume of small cavity 3 is between 250 ml and 350 ml; the volume of the middle cavity is between 100 ml and 150 ml; and the volume of the large cavity is between 60 ml and 100 ml.

As is especially apparent from FIG. 2, each cavity has a circular sampling orifice 6 on the top side of supporting body 2 and, moreover, a filling orifice 7. In the illustrated specific embodiment, the elongated, in particular oval filling orifice 7 is disposed on the bottom side of supporting body 2, diametrically opposing sampling orifice 6.

The orifice cross section of filling orifice 7 is smaller than that of sampling orifice 6. This design makes it possible, on the one hand, for a pipette needle to be used to draw reagents from cavities 3, 3′, 3″, without the pipette needle having to be exactly positioned for this purpose. In accordance with the present invention, the orifice cross section of filling orifice 7 is smaller than 20%, in particular smaller than 10% of the orifice cross section of sampling orifice 6. This permits an especially low gas content in the cavities filled with reagents.

In accordance with the present invention, in the case of a cavity 3, 3′ and, respectively, 3″ filled with liquid reagent, the air bubble or gas bubble remaining above the liquid surface level amounts to less than 2% of the volume of the particular cavity 3, 3′, 3″. The air bubble or gas bubble advantageously takes up less than 1%, in particular less than 0.5% of the volume of the particular cavity 3, 3′, 3″.

To prevent the reagents from escaping from cavities 3, 3′, 3″, sampling orifice 6 and filling orifice 7 are each sealed with a protective film. As a protective film, a plastic film may be used in particular, which is heat-sealed to supporting body 2. To facilitate the bonding to the protective film, a projecting bead 9 is formed on supporting body 2 around each cavity 3, 3′, 3″. The protective film may be bonded in the area of bead 9 or along joining line 8 to supporting body 2.

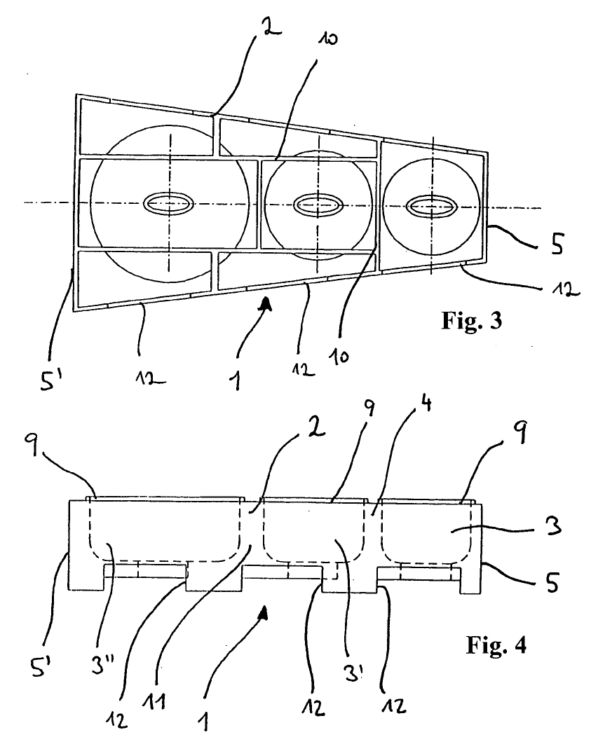

To achieve a high level of stability, supporting body 2 has intersecting reinforcing ribs 10 disposed on the bottom side, as shown in FIG. 3. In addition, the supporting body has a peripheral side wall 11, whose sections form longitudinal sides 4, 4′ and transversal sides 5, 5′. Adjoining side wall 11, in this context, is planar top side 42 of the supporting body, in which sampling orifices 6 of cavities 3, 3′, 3″ are provided. In addition, in the sections of side wall 11 forming longitudinal sides 4, 4′, three cutouts 12 are provided, which may be used for anchoring the reagent carrier in the analyzer unit.

The reagent carrier according to the present invention may include machine-readable information pertaining to the reagents contained in cavities 3, 3′, 3″. The machine-readable information may be provided in the form of a bar code or a dot code on the reagent carrier.

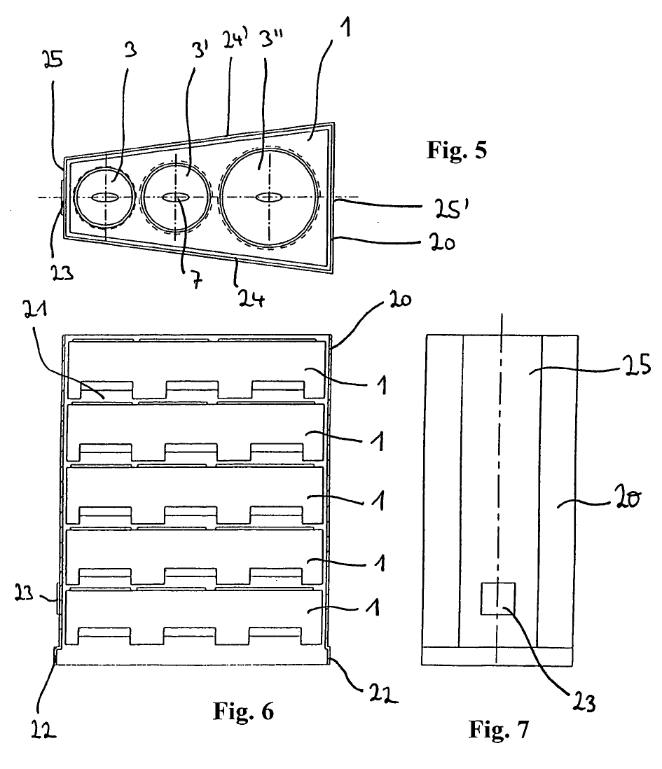

FIGS. 5 through 7 schematically show a transport container 20 having a receptacle chamber 21, which accommodates a plurality of previously described reagent carriers 1, stacked one over the other. The shape of transport container 20 is adapted to the exterior shape of reagent carrier 1, as can be inferred, in particular, from FIG. 5. Accordingly, transport container 20 has longitudinal sides 24, 24′, which are disposed at an angle to one another, as well as one shorter and one longer transversal side 25, 25′.

The illustrated transport container 20 not only has the function of safely transporting reagent carriers 1, but also of supplying reagent carriers 1 inside of it to the analyzer unit. To this end, transport container 20 has a connecting segment 22 for insertion into the analyzer unit, via which the reagent carriers are able to be individually removed in an automated process, from below, from receptacle chamber 21.

Transport container 20 includes machine-readable information pertaining to the at least one reagent carrier 1 contained in receptacle chamber 21 and/or pertaining to the reagents contained in the at least one reagent carrier 1. In the illustrated specific embodiment, the information is stored in a chip 23 arranged in or on transport container 20. In the place of a chip 23, other machine-readable information memories may also be used, however.

The stored machine-readable information pertains to reagent carriers 1 contained in receptacle chamber 21. This makes it possible for transport container 20 to be populated with reagent carriers 1, which are filled with various reagents, in order to deliver the reagents required for specific assays or combinations of assays, to the analyzer unit. In this context, the realization according to the present invention, including machine-readable information provided on transport container 20, provides substantial flexibility, since reagent carriers 1 having different reagents may be prepared in accordance with customer-specific requirements. Thus, transport container 20 may be populated with the various filled reagent carriers 1 in accordance with the customer's requirements. The analyzer unit is nevertheless able to automatically extract the information stored on transport container 20 regarding which reagents are contained in individual reagent carriers 1, in order to carry out the assays accordingly.

In addition, by storing calibration data regarding the assays to be carried out using the reagents, it is possible to enhance the accuracy of the assays. Thus, the relevant calibration data may be stored for each individual reagent carrier 1. This is useful since the properties of the reagents can influence the measuring accuracy. By storing relevant correction data, it is possible to correct the actual measuring results and, thus, to minimize any errors that occur.

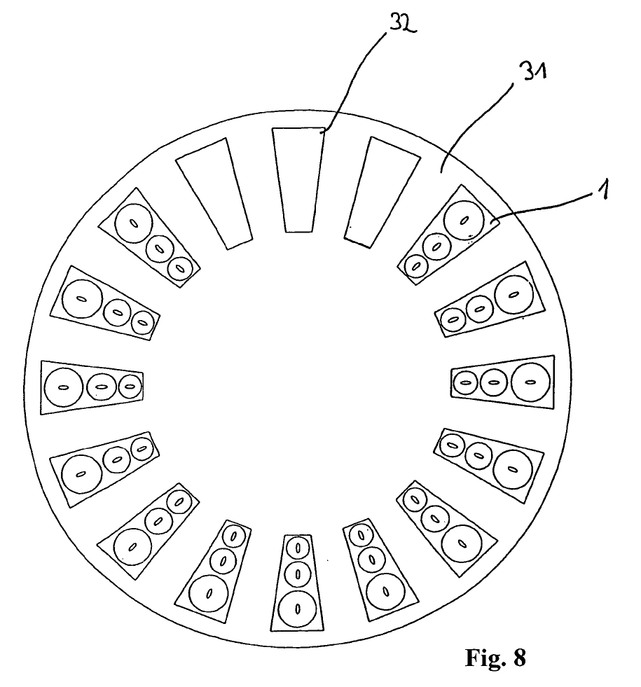

FIG. 8 schematically depicts a holding plate 31 of an analyzer unit in a plan view. Receptacles 32, into which reagent carriers 1 may be inserted and then removed after use, are provided in a circular array in the holding plate. The shape and dimensions of receptacles 32 correspond to those of reagent carriers 1, so that reference is made in this respect to the above description. By rotating holding plate 31 about a center axis, reagent carrier 1 needed in the particular instance may be brought to the desired position. Thus, FIG. 8 illustrates how the realization according to the present invention makes it possible for a large number of reagent carriers 1 to be placed on holding plate 31.

### REFERENCE NUMERAL LIST

1 reagent carrier
2 supporting body
3, 3′, 3″ cavity
4, 4′ longitudinal side
5, 5′ transversal side
6 sampling orifice
7 filling orifice
8 joining line
9 bead
10 reinforcing ribs
11 side wall
12 cutouts
20 transport container
21 receptacle chamber
22 connecting segment
23 chip
24, 24′ longitudinal side
25, 25′ transversal side
31 holding plate
32 receptacle
42 planar top side

What is claimed is:

1. A reagent carrier comprising:
a supporting body for insertion into an analyzer unit and having at least one cavity for receiving a reagent for analyzing a bodily fluid;
the supporting body having an elongated design having longitudinal sides and transversal sides, the transversal sides differing in length.

2. The reagent carrier as recited in claim 1 wherein the longitudinal sides are arranged at an angle to one another.

3. The reagent carrier as recited in claim 2 wherein the longitudinal sides form an angle of between 10° and 20°.

4. The reagent carrier as recited in claim 1 wherein the longitudinal sides are 25 mm to 35 mm long.

5. The reagent carrier as recited in claim 1 wherein the shorter transversal side is between 7 mm and 9 mm long, and the longer transversal side is between 14 mm and 18 mm long.

6. The reagent carrier as recited in claim 1 wherein the at least one cavity includes a plurality of cavities.

7. The reagent carrier as recited in claim 6 wherein the plurality of cavities includes first, second and third cavities varying in size.

8. The reagent carrier as recited in claim 7 wherein at least one of the following conditions applies: the first cavity has a volume of 250 to 350 ml, the second cavity has a volume of 100 to 150 ml and the third cavity has a volume of 60 to 100 ml.

9. The reagent carrier as recited in claim 6 wherein the first, second and third cavities are disposed side-by-side in a straight line.

10. The reagent carrier as recited in claim 1 wherein a reagent is contained in the at least one cavity.

11. The reagent carrier as recited in claim 1 wherein the at least one cavity has a sampling orifice on a top side of the reagent carrier.

12. The reagent carrier as recited in claim 11 wherein the at least one cavity has a filling orifice.

13. The reagent carrier as recited in claim 12 wherein the filling orifice is disposed on a bottom side of the reagent carrier.

14. The reagent carrier as recited in claim 12 wherein a filling orifice cross section of filling orifice is smaller than a sampling orifice cross section of sampling orifice.

15. The reagent carrier as recited in claim 12 wherein the filling orifice cross section of filling orifice is less than 20% of the sampling orifice cross section.

16. The reagent carrier as recited in claim 12 wherein the filling orifice has an elongated form.

17. The reagent carrier as recited in claim 12 wherein at least one of the sampling orifice and the filling orifice are sealed by a protective film.

18. The reagent carrier as recited in claim 1 wherein the reagent is contained in the at least one cavity in liquid form.

19. The reagent carrier as recited in claim 18 wherein an air bubble or gas bubble remaining above the liquid surface level of the reagent amounts to less than 2% of the volume of the at least one cavity.

20. The reagent carrier as recited in claim 18 wherein the air bubble or gas bubble takes up less than 1% of the volume of the at least one cavity.

21. The reagent carrier as recited in claim 1 wherein the reagent carrier includes machine-readable information pertaining to the reagent contained in the at least one cavity.

22. A transport container comprising:
a connecting segment for insertion into the analyzer unit; and
at least one receptacle chamber for a plurality of reagent carriers, at least one of the plurality of reagent carriers being a reagent carrier as recited in claim 1 and being contained in the receptacle chamber.

23. The transport container as recited in claim 11 further comprising machine-readable information pertaining to the at least one reagent carrier contained in the container and/or pertaining to the reagents contained in the at least one reagent carrier.

24. The transport container as recited in claim 23 wherein the machine-readable information is stored in a chip provided on or in the transport container.

25. The transport container as recited in claim 23 wherein the machine-readable information of the transport container includes calibration data regarding assays to be carried out using the reagents.
